(19) United States
(12) Patent Application Publication
(10) Pub. No.: US 2007/0261915 A1
(43) Pub. Date: Nov. 15, 2007

(54) Lifeline Trolley

(75) Inventor: Paul Auston, Sidcup (GB)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Checkmate UK Limited New Road, Sheerness ME12 1PZ (GB)

(21) Appl. No.: 10/582,469

(22) PCT Filed: Aug. 6, 2004
(86) PCT No.: PCT/GB04/03394

§ 371 Date: Apr. 10, 2007

(30) Foreign Application Priority Data
Dec. 13, 2003 (GB) 0328937.8

(51) Int. Cl. A62B 35/04

(52) U.S. Cl. 182/11

(57) ABSTRACT

A lifeline trolley (10) has a channel which fits over and runs along a fixed lifeline (12). A personal lifeline can be attached to the trolley, and the trolley has a brake (28) which is activated by a snatch loading on the personal lifeline to brake the trolley on the fixed lifeline.

This invention relates generally to fall arrest equipment, and in particular to a trolley adapted to travel along a fixed lifeline set up to allow personnel to connect their safety harnesses to the lifeline, so that they can move about while still being connected to the lifeline, through the trolley.

Safety of people working above the ground is an important issue. It is conventional for people working above the ground to wear a safety harness and for that harness to have a line or strop by which the harness can be connected to a fixed point, so if the person should slip, their weight will be taken, through the harness and the line, on the fixed point. In this specification, the line between the harness and the fixed point will be referred to as a personal lifeline.

When it is known that work will have to be carried out, for example on a roof, it is known to erect a fixed lifeline which extends in the area where work will be carried out. In this case, the workers can clip a karabiner or similar at the end of their personal lifeline onto the fixed lifeline, so that they can move around, with the karabiner sliding along the fixed lifeline.

Because such fixed lifelines necessarily have mounting brackets by which the line is fixed to the structure being worked upon, a simple karabiner will not allow a personal lifeline to pass a bracket. Thus lifeline trolleys are known to which a personal lifeline can be connected and which are designed to run on a fixed lifeline and to run past mounting brackets.

According to the invention, there is provided a lifeline trolley having a trolley body with a channel adapted to fit over a fixed lifeline to allow the trolley to travel along the lifeline, means for connecting a personal lifeline to the trolley body, and a brake which, when activated, brakes the trolley relative to a fixed lifeline on which it is travelling, wherein the brake is adapted to be activated by movement relative to the trolley body of the personal lifeline connecting means, to brake the trolley relative to the fixed lifeline.

The trolley is preferably adapted to run on a generally horizontal fixed lifeline.

The connecting means preferably comprises an elongate aperture through a body of the trolley, with a movable finger traversing the aperture and with the personal lifeline connected to the finger and movable in the aperture so that movement of the finger relative to the aperture activates the brake.

The brake preferably comprises a cam mounted for pivoting movement in the trolley body, with the movable finger forming part of the cam, and another part of the cam projecting into the channel to engage the lifeline, when the finger moves to rotate the cam.

The cam preferably has two fingers, both of which traverse the elongate aperture and the personal lifeline is located between the two fingers so that movement of the personal lifeline in either direction causes the cam to rotate.

The cam is preferably symmetrical about a vertical axis.

The trolley may include a karabiner fitted in the aperture, with a limb of the karabiner located between the two fingers of the cam. A user can then clip his personal lifeline into the karabiner.

The channel for accommodating the lifeline wire preferably has an opening at one point around its circumference to allow the trolley to pass a lifeline support bracket. the opening is preferably at a part of the circumference where it will not lie against the lifeline during use.

The invention will now be further described, by way of example, with reference to the accompanying drawings, in which:

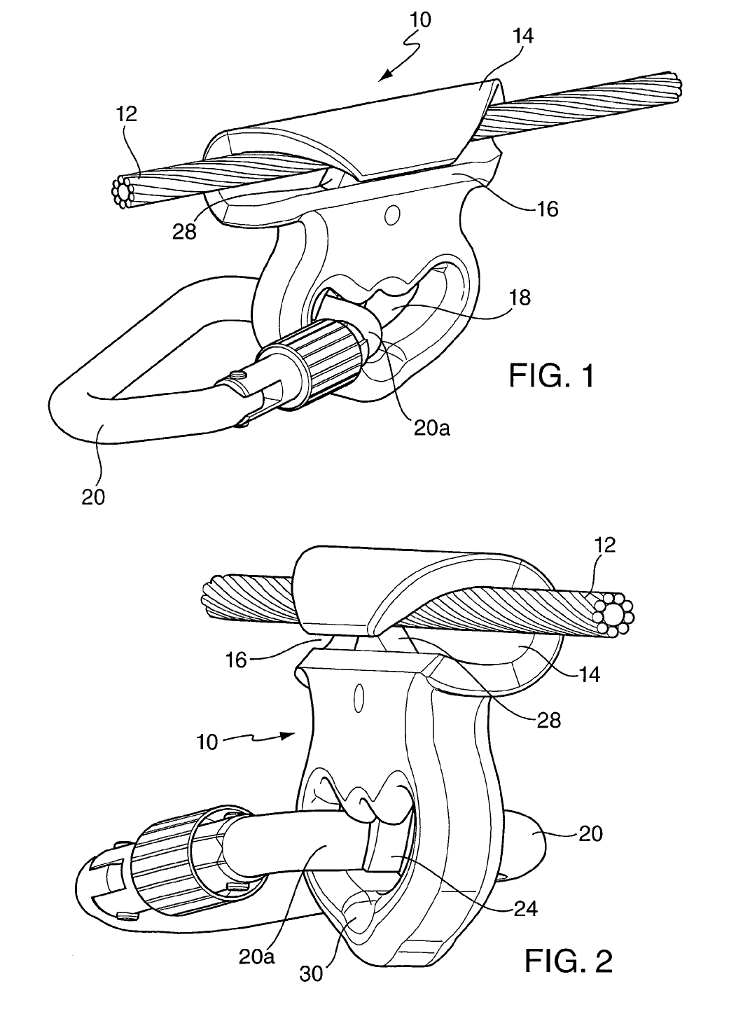

FIG. 1 is a first perspective view of a trolley according to the invention on a lifeline;

FIG. 2 is a second perspective view of the trolley of FIG. 1;

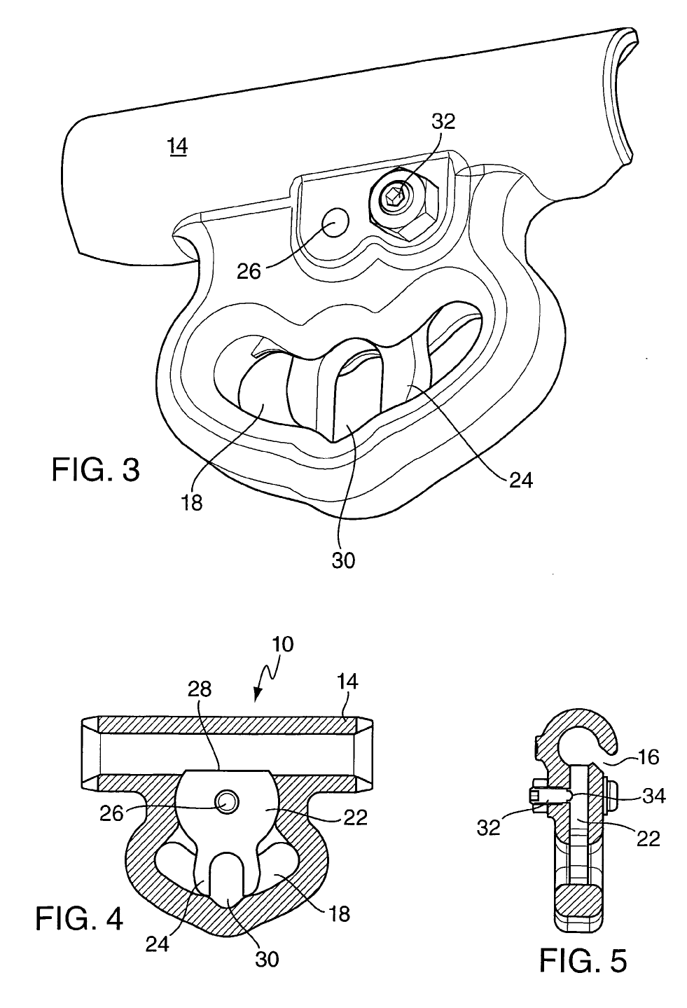

FIG. 3 is a third perspective view of the trolley of FIG. 1;

FIG. 4 is a longitudinal section through the trolley; and

FIG. 5 is a transverse section through the trolley.

FIG. 1 shows a trolley generally designated 10 in place on a wire lifeline 12. The lifeline will be tensioned between mounting brackets on a structure where workmen will be working above the ground, in a manner which is well known. The trolley 10 has a body with a tubular portion 14 within which the lifeline 12 is received. The tubular portion 14 is able to slide freely in either direction along the lifeline. The tubular portion also has a mouth 16 (see particularly FIG. 5) which is too narrow to allow the trolley to be removed from the lifeline 12, but which will allow the trolley to pass lifeline support brackets (not shown), in a manner known per se.

A lower portion of the body has an aperture 18 into which a personal lifeline can be connected. In the figures, a karabiner 20 is shown in position in the aperture 18. This karabiner may be permanently fixed to a user's personal lifeline, or another karabiner or other hook on the end of the personal lifeline may be connected into the karabiner 20. The latter is preferable.

Within the body of the trolley is a cam 22. As can be seen in FIG. 4, the cam has a fork 24 which extends across the aperture 18. The cam is mounted for pivoting movement on an axle 26, and has a cam face 28. As can be seen in FIGS. 1 and 2 the karabiner 20 has a limb 20a which is located between the two limbs of the fork 24. Under normal conditions, the cam 22 will be in the central position as shown in FIGS. 3 and 4, and the limb 20a of the karabiner will lie in a recess 30 of the aperture 18. However, if there is a sudden load on the karabiner, as a result of a workman falling or losing his balance, the karabiner will move to one or other end of the aperture 18, causing the cam 22 to pivot about the axis 26, whereupon the cam face 28 projects into the cross-section of the tubular portion 14 and jams the trolley against the lifeline 12. This is shown in FIGS. 1 and 2.

To prevent this locking action happening too readily, which would obstruct normal motion of the trolley along the length of the lifeline 12, a spring loaded pin 32 normally holds the cam 22 in its middle position as shown in FIG. 5. The pin 32 engages in a detent 34 in the cam. However, a sharp load on the cam will overcome the spring force which holds the pin 32 in the detent 34 so that the cam can move to one side or the other to lock the trolley to the lifeline. The recess 30 also helps gravity to keep the karabiner in the central position under normal conditions.

The trolley body is preferably a single cast component.

It will be noted that the mouth 16 of the tubular portion 14 is only open at a lower region of the tubular portion so that when a load comes on a trolley the lifeline is not pulled against the mouth 16. Also, the ends 14a and 14b of the slot 14 are chamfered so that when the trolley approaches a mounting bracket, it is caused to rotate about the axis of the lifeline to enable it to pass the mounting bracket.

All of these features make for a rugged trolley with a simple locking mechanism which will not lock on the lifeline unless it is subjected to a sudden snatch load, but will lock under those conditions. The level of load at which locking will take place can be adjusted by setting of the spring tension on the pin 32.

1. A lifeline trolley having a trolley body with a channel adapted to fit over a fixed lifeline to allow the trolley to travel along the lifeline, means for connecting a personal lifeline to the trolley body, and a brake which, when activated, brakes the trolley relative to a fixed lifeline on which it is travelling, wherein the brake is adapted to be activated by movement relative to the trolley body of the personal lifeline connecting means, to brake the trolley relative to the fixed lifeline.

2. A trolley as claimed in claim 1, wherein the trolley is adapted to run on a generally horizontal fixed lifeline.

3. A trolley as claimed in claim 1, wherein the connecting means comprises an elongate aperture through the trolley body, with a movable finger traversing the aperture and engageable with a personal lifeline terminal fitting such that movement relative to the trolley of a personal lifeline terminal fitting engaged with the finger moves the finger in the aperture to activate the brake.

4. A trolley as claimed in claim 3, wherein the brake comprises a cam forming part of the movable finger and mounted for pivoting movement in the trolley body, such that pivoting movement of the movable finger causes part of the cam to project into the channel to engage the lifeline.

5. A trolley as claimed in claim 3, wherein the cam has two fingers, both of which traverse the elongate aperture with a space between them to receive a personal lifeline terminal fitting so that movement of the terminal fitting in either direction causes the cam to rotate.

6. A trolley as claimed in claim 4, wherein the cam is symmetrical on either side of a plane which extends through the cam pivot mounting and normal to the axis of the channel.

7. A trolley as claimed in claim 5, including a karabiner fitted in the aperture, with a limb of the karabiner located between the two fingers of the cam.

8. A trolley as claimed in claim 1, wherein the channel for accommodating the lifeline wire has an opening at one point around its circumference to allow the trolley to pass a lifeline support bracket.
